(19) United States
(12) Patent Application Publication
(10) Pub. No.: US 2020/0057971 A1
(43) Pub. Date: Feb. 20, 2020

(54) Risk response and communication system

(71) Applicant: SAP SE, Walldorf (DE)

(72) Inventors: Elias Moreira, Rio de Janeiro (BR); Steven Garcia, South Riding, VA (US); Vaibhav Vohra, San Ramon, CA (US); Rohit Tripathi, San Ramon, CA (US); Khalid Abdullah, Reston, VA (US); Noel Ferreira, Sao Paulo (BR); Rajat Krishnan, Bangalore (IN); Mohit Goel, Delhi (IN)

(21) Appl. No.: 15/998,998

(22) Filed: Aug. 20, 2018

(51) Int. Cl. G06Q 10/06; H04W 4/14; H04W 4/029; H04W 4/90

(52) U.S. Cl. CPC G06Q 10/0633; H04W 4/90; H04W 4/029; H04W 4/14

(57) ABSTRACT

Disclosed herein are system, method, and computer program product embodiments for p providing a risk response and communication system. An embodiment operates by determining that a workflow associated with an organization indicates an action to be taken by a role within the organization upon the detection of an organizational risk. An organizational risk is detected. Contact information associated with the role is determined, wherein the contact information includes a user account. A message notifying the user account associated with the role of the organizational risk is sent, wherein the notification includes an indication to take the action. It is determined whether a response indicating the action has been completed is received within a time threshold. The user account is monitored until either the response is received or the expiration of the time threshold.

### BACKGROUND

When a company or other organization encounters a threat to its ongoing operations or its staff, such as a cyber-attack, natural disaster, or terrorism, there are often no processes in place for managing the threat. Organizations often do not have a reliable way to manage communications during an impending or ongoing threat, other than sending an e-mail to everyone in the company (including those who are not affected by the threat). But this mass communications approach fails to provide any indicator or measure that the threat has been managed, and it consumes unnecessary network bandwidth and processing resources that could otherwise be used to manage the threat or support ongoing operations.

### BRIEF DESCRIPTION OF THE DRAWINGS

The accompanying drawings are incorporated herein and form a part of the specification.

FIG. 1 is a block diagram illustrating example functionality for providing a risk response and communication system (RRCS), according to some embodiments.

FIG. 2 is a flowchart illustrating example operations of a RRCS, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a risk response and communication system.

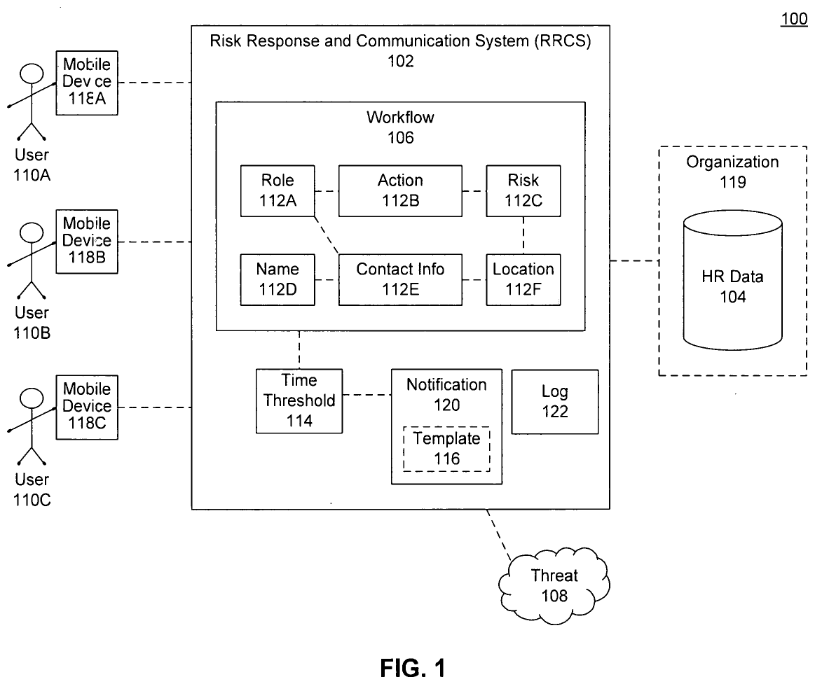

FIG. 1 is a block diagram 100 illustrating example functionality for providing a risk response and communication system (RRCS) 102, according to some embodiments. RRCS 102 may detect organizational threats 108 and provide automated communications that reduce or even minimize both bandwidth and processor usage while monitoring and logging responses and user actions 112B. A log 122 may provide indicators as to when notifications 120 about the threat 108 were transmit, and when actions 112B for managing the threat were taken. RRCS 102 may manage and monitor communications during ongoing or potential threats 108.

A threat 108 may be an event that disrupts (or potentially disrupts) the ability of one or more members of an organization to perform a particular action or fulfill a particular duty. Threat 108 may threaten the security of employees or other members of an organization 119, or may prevent one or more employees from fulfilling his/her duties.

Example threats 108 may include fires, natural disasters, terrorist activity, fraud, device failures and maintenance, network failures, supply-chain threats, machine malfunctions, cyber-attacks or other security threats, to name just some examples. For example, an impending storm may be declared as a threat 108 for different organizations 119, including a supplier company who owns the factory, a material company that supplies material to the factory, and/or a customer company that receives products output from the factory. Some threats 108 may be planned or scheduled for ahead of time, such as holidays, office moves, or machine/equipment maintenance. In an embodiment, threats 108 may be categorized between planned and unplanned disruptions.

Organization 119 may include a group of individuals who are working together towards the fulfillment of any task, goal, or duty. Example organizations 119 include corporations, non-profit organizations, churches, schools, families, government organizations, and charities.

When a threat 108 is detected, RRCS 102 may provide and/or manage communications amongst employees or other members of one or more organizations 119 that are affected or potentially affected by the threat 108. For example, a particular company 119 may have thousands of employees working at different offices and factories located in different cities around the world. The company 119 may include different divisions, some of which interact with each other, and some of which may operate as independent subsidiaries underneath an umbrella organization.

With such a company 119, a particular threat 108 may not affect all of the different divisions and employees of the company. For example, a network outage in the Sydney office may not affect operations in the New York City office. Thus, rather than sending a mass communication to all the employees of the company and all its various divisions and locations, many of whom may not be affected by the threat 108, RRCS 102 provides a more targeted approach to communications.

Mass communications, particularly to individuals who are not affected by the threat 108, unnecessarily consume large amounts of network bandwidth and other processing resources, including employee time in checking and discarding the notifications. RRCS 102 may reduce or even minimize the bandwidth and processor usage, and save other company resources, by focusing communications on those members or employees (e.g., users 110) that need to receive the notifications 120 about the threat 108.

In an embodiment, RRCS 102 may leverage human resources (HR) and other organizational data 104 into a workflow 106 that enables RRCS 102 to manage communications during potential and ongoing organizational threats 108. In an embodiment, an organization 119 may maintain HR data 104 about its employees or members. Example HR data 104 may include names, roles, responsibilities, pay, location, contact information, length of service, previous experience, procedures or protocols for responding to threats 108, or other information. RRCS 102 may receive or retrieve HR data 104 from a corporate network, or RRCS 102 may import one or more files or databases into workflow 106.

RRCS 102 may import and organize HR data 104 into a workflow 106. Workflow 106 may include a communications-based organizational flow between the employees or members of organization 119 fulfilling various roles 112A. Users 110 may include the members, employees, or other affected parties affiliated with organization 119 with whom RRCS 102 communicates or manages communications.

In an embodiment, workflow 106 may incorporate previously established threat response procedures (from HR data 104) or may generate such procedures based on hierarchical information of HR data 104. In an embodiment, different workflows 106 may exist for different threats 108. For example, a flood may be handled or managed by different users 110 or roles 119A than a fire, even if both occur in the same office location. In an embodiment, workflow 106 may include or incorporate role 112A, action 112B, risk 112C, name 112D, contact info 112E, and/or location 112F information.

Role 112A may include a particular title or position within an organization 119. Example roles 112A may include CEO, vice-president, manager, sales associate, programmer, director, intern, engineer, assistant, etc. In an embodiment, workflow 106 may indicate a hierarchy or communication pathway amongst roles 112A when various threats 108 are detected. In an embodiment, workflow 106 may indicate one or more roles 112A that are contacted first and who are responsible for taking one or more actions 112B, which may include contacting other employees (users 110/roles 112A), obtaining more information, and/or making decisions as to the work and operating status of portions of organization 119.

Action 112B may indicate what decisions, actions, communications, or other responsibilities are assigned to the person in role 112A when a particular threat 108 is detected. In an embodiment, action 112B may indicate which employees a particular manager or user 110A is responsible for contacting about threat 108. Or, for example, action 112B may indicate that users 110A, 110B, and 110C may need to make a unanimous or majority decision together as to whether or not to close an office in response to a detected or identified threat 108. Action 112B may indicate a particular time threshold 114 within which a response must be received or action 112B completed.

Risk 112C may identify one or more threats 108 for which workflow 106 is configured. In an embodiment, RRCS 102 may implement the same workflow 106 across multiple different risks 112C. Then for example, if any of the identified risks 112C are detected as threats 108, RRCS 102 may implement the corresponding workflow 106.

For example, a network administrator (role 112A) may be responsible for notifying (action 112B) a team of technical engineers in the case of a network outage (risk 112C) or cyber-attack (risk 112C). Then, for example, when a network outage or cyber-attack threat 108 is detected, the network administrator (user 110A) may be contacted to take action 112B based on the risk profile 112C within any specified time threshold 114. However, a different risk 112C, such as an earthquake may use a different workflow 106. For example, a notification 120 may be sent to both the network administrator and the team of technical engineers at the same time so that they can get themselves to safety.

Role 112A, action 112B, and risk 112C may be the top-level of a workflow 106. The top-level of workflow 106 may be indicative of an organizational structure or hierarchy of organization 119. In an embodiment, workflow 106 may also include a lower level or HR data specific information such as name 112D, contact info 112E, and location 112F. The lower level information may include information or data specific to individuals hired into the roles 112A.

In continuing the network administrator example, name 112D may indicate the name of particular individual hired as a network administrator (e.g., Pete Carroll). Contact info 112E may include e-mail address, work address, home address, phone number, social media handles, work hours, vacation or working status, or other contact information for reaching Pete Carroll. Location 112F may indicate a real-time location of Pete Carroll (e.g., as obtained from his mobile device or social media posts), and/or office locations for which Pete Carroll is responsible. For example, Pete Carroll may be responsible for maintaining the communications network in the Seattle location of a particular facility or office.

In an embodiment, location 112F may be a top-level and/or lower level feature. While location 11F may indicate a location of an employee, it may also be indicative of a location of a risk 112. Because for example, a risk 112C may be location specific (e.g., only for the Miami office).

In an embodiment, the top-level workflow 106 may be reused across different organizations 119. For example, a particular company may include four different subsidiary companies each of which operates independently. However, these companies may use the same workflow when managing risks 11C. As such, RRCS 102 may implement a similar or identical workflow 106 across different sets of HR data 104 for each subsidiary.

However, HR data 104 may not always be accurate or up-to-date. In times of threats or emergencies, incorrect data could be very costly and could threaten lives, money, and other company resources. For example, if the wrong phone number exists for the network administrator and a message is sent to the network administrator, and no response is received, that could cost a company millions of dollars in revenue and productivity while the network is down. An issue such as this may require additional processing resources to get the network up and running again after it is restored versus the resources that would be necessary if a notification 120 of the threat 108 was received by the network administrator user 110A earlier with verified phone number information 112E.

As such, RRCS 102 may perform data verification prior to the detection of a threat 108. Data verification may include sending messages to the various electronic contact info 112E. A verification communication or message may include a text message to a mobile phone number asking the recipient to confirm that they are the person indicated by name 112D and have been hired into role 112A. The verification communication may inform the individual their role or actions 112B they will be required to take if a particular risk 112C is detected. Other example verification communications or notifications 120 may include automated phone calls, text messages, social media posts, and e-mails.

In an embodiment, the verification communications may include time thresholds 114. Then, for example, upon the expiration of a particular time threshold 114 a reminder notification may be communicated using the same or different contact info 112E. For example, if no response is received to a text message within threshold 114, a subsequent automated phone call may request user input to verify the information. If no response is received within time threshold 114, or a negative reply is received, then a message may be transmitted or the HR department or another role 112A may be contacted and informed of a negative or non-response.

In an embodiment, RRCS 102 may maintain the imported data 104 and workflow 106, including status information indicating whether or not the lower level information has been confirmed or verified, the method of verification, and the date of verification. Example status information may include missing (if information does not exist, like a missing phone number), valid (the information is in the proper format, such as a phone number format), invalid (the information is in the wrong format, such as an e-mail address missing the @ symbol), not validated (if no verification request has been sent), certified (if an employee has confirmed the information), or pending/uncertified (if a verification request has been sent but a response has not yet been received and time threshold 114 has not yet expired). In an embodiment, the status information may be stored with workflow 106 or within log 122.

Different threats 108, such as weather, network outages, terrorism, and natural disasters may be location centric, or may require a user 110 to be physically located within a particular geographic vicinity to take action (in accordance with action 112B) with regard to managing the risk 112C. For example, a manager who is on vacation in Hawaii may not be able to resolve a network virus issue in the London office. As such, in an embodiment, RRCS 102 may track the location 112F of users 110. Then, for example, RRCS workflow communications may be adjusted based on real-time locations 112F and statuses (out sick, on vacation, parental leave, on call, etc.) of users 110. For example, workflow 106 may include contingency actions 112B in case particular individuals in particular roles 112A are unavailable.

In an embodiment, RRCS 102 may detect a threat 108 based on news stories, social media scanning, weather reports, the status of machinery or network devices, bandwidth usage, or user input. Upon detection of a threat 108, RRCS 102 may identify a corresponding risk 112C from a set of one or more workflows 106 for the company or organization.

Based on the identified workflow 106, RRCS 102 may transmit a notification 120 of the risk 112C to the responsible roles 112A using the (preferably verified or confirmed) contact info 112E. Notification 120 may include an identification of one or more responsibilities or actions 112B requested from or required by the receiving user 110A. Notification 120 may also indicate a time threshold 114 in which a response is requested.

In an embodiment, RRCS 102 may receive or monitor actions or communications that a user 110 takes on a user or mobile device 118 after receipt of notification 120. For example, RRCS 102 may receive communications, track phone calls, receive text messages, monitor a user's social media posts, monitor an app or web-based program usage, or monitor or receive other communications from a mobile device 118. Mobile device 118 may include a mobile phone, laptop, desktop, smart television, tablet, or other computing device. In an embodiment RRCS 102 may track responses and communications in log 122.

In an embodiment, notification 120 may include a template 116 that a user 110 may use to perform an action 112B or notify another user 110. For example, template 116 may include a preformatted e-mail (including the e-mail addresses of one or more employees) for which the user 110A may verify the information and hit send. Or, for example, notification 120 may include a requested response (such as a radio button or yes/no response from a user 110 indicating whether a particular office location is open or closed). In an embodiment, user 110 may authorize RRCS 102 to monitor communications coming in to or originating from a mobile device 118.

If action 112B indicates that a user 110A needs to send an e-mail to employees X, Y, and Z, then RRCS 102 may monitor e-mails originating from the user account of user 110A. If no e-mails to the indicated employees are sent within time threshold 114, then a reminder may be transmit to user 110A. Or, for example, the notification 120 may be transmit to another user or a supervisor 110B of the original user 110A informing them that no response was received.

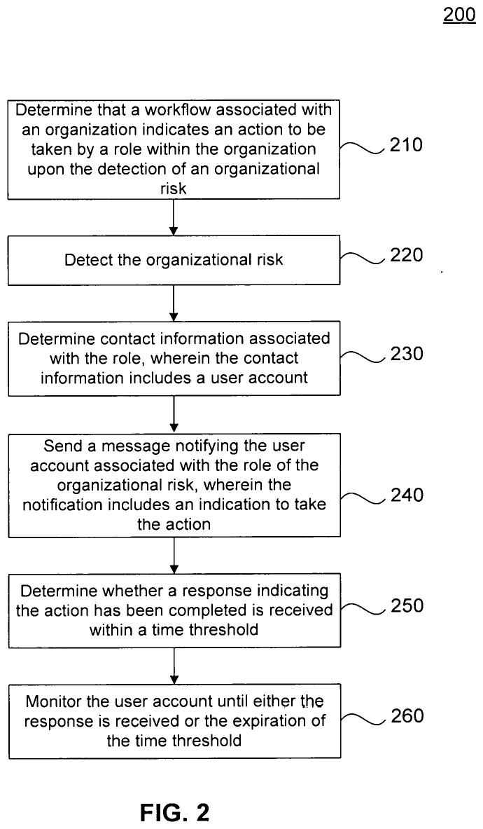

FIG. 2 is a flowchart 200 illustrating example operations of operations of a risk response and communications system (RRCS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1. However, method 200 is not limited to the example embodiments.

In 210, upon detection of an organizational risk, it is determined that a workflow associated with an organization indicates that an action is to be taken by a role within the organization. For example, RRCS 102 may import or construct workflow 106 from HR data 104. Workflow 106 may include an indication as to which role(s) 112A are responsible for taking specified action(s) 112B when a particular risk 112C is detected. The risks 112C may be any organization threat 108 to the ongoing operations or safety of any aspect of an organization 119, such as a company.

In 220, the organizational risk is detected. For example, a user 110C watching a weather report may send a text message using their mobile device 118C that there is a threat 108 of flooding at a factory in Mumbai, India. The text message may be received by RRCS 102 and may be interpreted as a flood risk 112C for the Mumbai factory (location 112F). The text message may be recorded in log 122.

In 230, contact information associated with the role is determined, wherein the contact information includes a user account. For example, RRCS 102 may determine a telephone number, e-mail address, or user ID associated with a person in an executive role 112A responsible for the factory in Mumbai. Role 112A may also include a set of managers each in charge of different departments that operate within the factory, all of whom RRCS 102 may be notified of the flooding risk 112C according to workflow 106.

In 240, a message notifying the user account associated with the role of the organizational risk is sent, wherein the notification includes an indication to take the action. For example, RRCS 102 may send a pre-configured notification 120 to the mobile devices 118 of the responsible roles 112A using the contact info 112E (which may have been previously verified). The notification 120 may include a text message, e-mail message, automated phone call, or other contact. In an embodiment, the notification 120 may indicated what action(s) 112B the receiving party is to perform within a particular time threshold 114. Example actions may include sending an e-mail, sending a text message, communicating a decision, or clicking a link. This notification 120 may be logged.

In 250, it is determined whether a response indicating that the action has been completed is received within a time threshold. For example, notification 120 may include an indication of a time threshold 114 by which a user 110 is requested to take a specified one or more actions 112B. The actions 112B may be any action that is associated with managing and/or mitigating the organizational impact or threat of the risk 112C. Actions 112B may include registering a decision (e.g., whether to close the factory, evacuate, continue working under normal operating conditions, notifying employees, etc.).

In an embodiment, notification 120 may include a hyperlink that allows the receiving user 110 to complete the action 112B. For example, if action 112B requires user 110B to send a text message to five different employees, a hyperlink in notification 120 may allow user 110B to automatically send a preconfigured template 116 text message to the phone numbers associated with the employees. Or, for example, the link may enable user 110B to modify the text message template 116 and/or recipients prior to sending.

In an embodiment, RRCS 102 may monitor the incoming or outgoing electronic communications from device 118B (with user's 110B authorization or permission) to determine whether or not the action 112B was completed within the threshold 114. Or, for example, RRCS 102 may monitor user interactions with an app or web-based program that distributes electronic communications to various employees or users 110 of an organization to determine with the actions 112B have been completed. In an embodiment, RRCS 102 may send a message to a particular mobile device 118C or user account (such as an e-mail address) requesting user 110B to confirm that the specified action(s) 112B have been completed. Each of these communications may be logged, and provide indications as to how threat 108 was managed.

In 260, the user account may be monitored until either the response is received or the expiration of the time threshold. For example, RRCS 102 may monitor an app on a mobile device 118 of a user 110 that is supposed to take an action 112B until an indication that the action 112B has been completed is received. Or, for example, upon expiration of the time threshold 114, as determined by a timer or calendar/clock, RRCS 102 may send a reminder message to the same or different users 110 again requesting that the action is performed. RRCS 102 may then monitor multiple user accounts or mobile devices 118 until an indication that the action 112B was completed, the action 112B is not necessary, or the threat 108 is no longer active.

For example, in an embodiment, a secondary user 110 in another role 112A (as determined from workflow 106) may also be notified 120 of a primary user's failure to complete the action 112B within the specified time threshold 114. This may enable RRCS 102 to account for the possibility that the primary user 110 is unavailable or their device 118 is not working properly. Thus, RRCS 102 may empower another user 110 to manage the risk 112C on behalf of the original or primary user 110, taking over their responsibilities or actions. Upon receiving a confirmation from the backup or secondary user, RRCS 102 may notify the original or primary user that their responsibilities or actions 112B have been transferred to the secondary user.

Or, for example, the threat 108 may have been a tsunami warning. However, an indication may be received by RRCS 102 that no tsunami is going to occur in the specified location 112F. Then, for example, RRCS 102 may send a notification 120 indicating that the risk 112C no longer exists and no further actions 112B are necessary. However, RRCS 102 may log any actions 112B that are or were taken, so that they may be reviewed later to improve workflow 106.

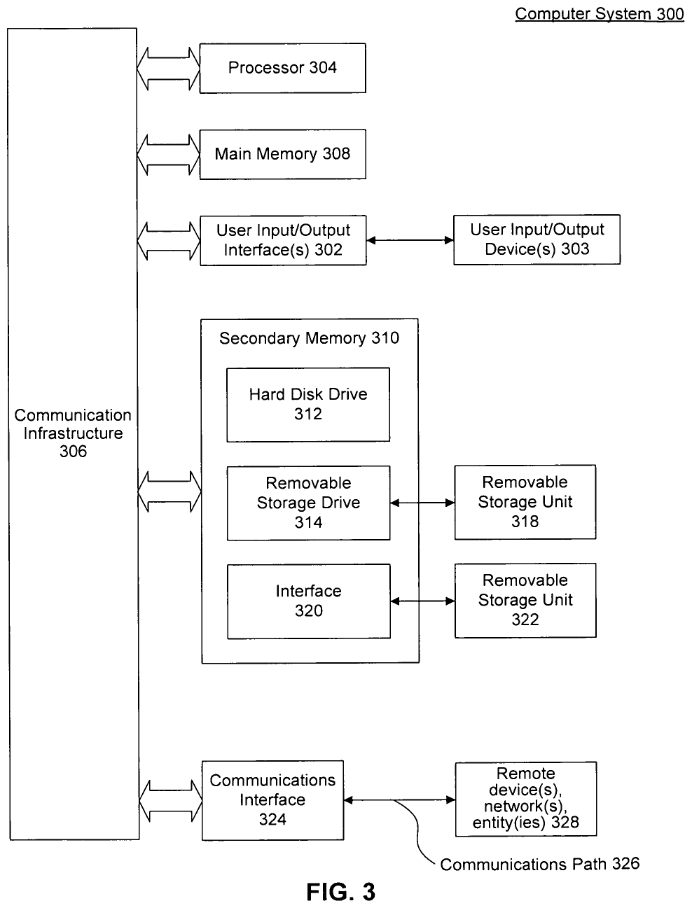

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include customer input/output device(s) 303, such as monitors, keyboards, pointing devices, etc., which may communicate with communication infrastructure 306 through customer input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
determining that a workflow associated with an organization indicates an action to be taken by a role within the organization upon a detection of an organizational risk;
detecting the organizational risk;
determining contact information associated with the role, wherein the contact information includes a user account;
sending a message notifying the user account associated with the role of the organizational risk, wherein the notification includes an indication to take the action;
determining whether a response indicating the action has been completed is received within a time threshold; and
monitoring the user account until either the response is received or an expiration of the time threshold.

2. The method of claim 1, wherein the determining the contact information comprises:
determining that the contact information includes a telephone number for a mobile device associated with the user account;
sending a text message, to the telephone number, requesting a confirmation that the mobile device is associated with the role; and
receiving a confirmation response from the mobile device confirming that the mobile device is associated with the role.

3. The method of claim 2, wherein the sending the message comprises:
sending the message to the telephone number after the confirmation response has been received, wherein the confirmation response is received prior to the detecting the organizational risk.

4. The method of claim 2, wherein the determining whether the response indicating the action has been completed is received within the time threshold comprises:
determining a dependent user account that is associated with the action, wherein the action indicates the message is to be transmitted from the role to the dependent user account within the time threshold; and
determining that an electronic communication originating from one of the mobile device or the user account was transmitted to the dependent user account within the time threshold.

5. The method of claim 4, wherein the notifying comprises:
providing a template for the electronic communication originating from one of the mobile device or the user account of the role.

6. The method of claim 5, wherein the determining whether the response indicating that the action has been completed comprises:
determining whether the template for the response was sent, wherein the template includes one or more modifications made by the mobile device.

7. The method of claim 1, wherein the determining the contact information comprises:
tracking a location of a mobile device associated with the role;
determining that the location of the mobile device is associated with the organizational risk; and
sending the message to the mobile device.

8. The method of claim 1, wherein the message comprises an indication of the organizational risk, the action, and the time threshold.

9. A system, comprising:
a memory; and
at least one processor coupled to the memory and configured to:
determine that a workflow associated with an organization indicates an action to be taken by a role within the organization upon a detection of an organizational risk;
detect the organizational risk;
determine contact information associated with the role, wherein the contact information includes a user account;
send a message notifying the user account associated with the role of the organizational risk, wherein the notification includes an indication to take the action;
determine whether a response indicating the action has been completed is received within a time threshold; and
monitor the user account until either the response is received or an expiration of the time threshold.

10. The system of claim 9, wherein the at least one processor configured to determine the contact information is configured to:
determine that the contact information includes a telephone number for a mobile device associated with the user account;
send a text message, to the telephone number, requesting a confirmation that the mobile device is associated with the role; and
receive a confirmation response from the mobile device confirming that the mobile device is associated with the role.

11. The system of claim 10, wherein the at least one processor configured to send the message is configured to:
send the message to the telephone number after the confirmation response has been received, wherein the confirmation response is received prior to the detecting the organizational risk.

12. The system of claim 10, wherein the at least one processor configured to determine whether the response indicating the action has been completed is received within the time threshold is configured to:
determine a dependent user account that is associated with the action, wherein the action indicates the message is to be transmitted from the role to the dependent user account within the time threshold; and
determine that an electronic communication originating from one of the mobile device or the user account was transmitted to the dependent user account within the time threshold.

13. The system of claim 12, wherein the at least one processor that notifies is configured to:
provide a template for the electronic communication originating from one of the mobile device or the user account of the role.

14. The system of claim 13, wherein the at least one processor that determines whether the response indicating that the action has been completed is configured to:
determine whether the template for the response was sent, wherein the template includes one or more modifications by the mobile device.

15. The system of claim 9, wherein the at least one processor that determines the contact information is configured to:
track a location of a mobile device associated with the role;
determine that the location of the mobile device is associated with the organizational risk; and
send the message to the mobile device.

16. The system of claim 9, wherein the message comprises an indication of the organizational risk, the action, and the time threshold.

17. A non-transitory computer-readable device having instructions stored thereon that, when executed by at least one computing device, cause the at least one computing device to perform operations comprising:
determining that a workflow associated with an organization indicates an action to be taken by a role within the organization upon a detection of an organizational risk;
detecting the organizational risk;
determining contact information associated with the role, wherein the contact information includes a user account;
sending a message notifying the user account associated with the role of the organizational risk, wherein the notification includes an indication to take the action;
determining whether a response indicating the action has been completed is received within a time threshold; and
monitoring the user account until either the response is received or an expiration of the time threshold.

18. The non-transitory computer-readable device of claim 17, wherein the determining the contact information comprises:
determining that the contact information includes a telephone number for a mobile device associated with the user account;
sending a text message, to the telephone number, requesting a confirmation that the mobile device is associated with the role; and
receiving a confirmation response from the mobile device confirming that the mobile device is associated with the role.

19. The non-transitory computer-readable device of claim 18, wherein the sending the message comprises:
sending the message to the telephone number after the confirmation response has been received, wherein the confirmation response is received prior to the detecting the organizational risk.

20. The non-transitory computer-readable device of claim 18, wherein the determining whether the response indicating the action has been completed comprises:
determining a dependent user account that is associated with the action, wherein the action indicates the message is to be transmitted from the role to the dependent user account within the time threshold; and
determining that an electronic communication originating from one of the mobile device or the user account was transmitted to the dependent user account within the time threshold.
